(19) United States
(12) Patent Application Publication
(10) Pub. No.: US 2023/0135647 A1
(43) Pub. Date: May 4, 2023

(54) METHOD FOR PRODUCING A BRAKE DISC, AND A BRAKE DISC

(71) Applicant: IMPACT-Innovations-GmbH, Rattenkirchen (DE)

(72) Inventors: Andreas GROPP, Kirchdorf (DE); Peter RICHTER, Heldenstein (DE); Leonhard HOLZGASSNER, Reichertsheim (DE); Reeti SINGH, Mühldorf (DE); Ján KONDÁS, Ampfing (DE); Maximilian MEINICKE, Rattenkirchen (DE); Sebastian PICHLMEIER, Aschau am Inn (DE)

(21) Appl. No.: 17/975,052

(22) Filed: Oct. 27, 2022

(30) Foreign Application Priority Data
Oct. 29, 2021 (DE) 10 2021 128 374.4

(51) Int. Cl. F16D 65/12; C23C 24/04; C22C 29/06; F16D 69/02

(52) U.S. Cl. CPC F16D 65/127; C23C 24/04; C22C 29/06; C22C 29/067; F16D 69/027; F16D 2250/0046; F16D 2200/0017; F16D 2065/132

(57) ABSTRACT

In a method for producing a brake disc, a friction surface layer is sprayed onto the base body or onto an intermediate layer applied on the base body by cold gas spraying a particle mixture which consists 25 to 75% by weight of a metal matrix material and 75 to 25% by weight of a carbide material. The metal matrix material consists of an iron-based alloy, nickel-based alloy, titanium or titanium alloy. The carbide material consists of tungsten carbide, titanium carbide, iron carbide, silicon carbide, chromium carbide or niobium carbide.

### CROSS-REFERENCE TO RELATED APPLICATION

This application claims priority to DE Patent Application No. 10 2021 128 374.4 filed Oct. 29, 2021, the entire contents of which is hereby incorporated by reference.

### FIELD

The technology relates to a method for producing a brake disc and to a brake disc for a disc brake.

### BACKGROUND AND SUMMARY

Brake discs that are used for disc brakes of motor vehicles usually have a base body, e.g., consisting of grey cast iron, cast steel or cast aluminium, having lateral surfaces which serve as friction surfaces. It is also known to produce the base body from polymer materials or from a composite material.

Disc brakes are friction brakes. The braking effect or delay of the vehicle usually occurs when brake pads that are provided with brake linings are pressed against the friction surfaces of the rotating brake disc from opposite sides in a mechanical, hydraulic or pneumatic manner. In this case, the brake disc has an annulus-shaped friction surface on each of its two sides. Brake discs, in the case of which the entire lateral surfaces of the brake disc are available as friction surfaces, are further also used for full disc brakes.

Known brake discs usually undergo significant wear stemming from the high frictional forces and the heat release which depends on said frictional forces. The corrosion susceptibility of known brake discs represents a further problem.

Coating methods of all kinds are further known, by means of which parts or other substrates, which can, for example, consist of metal or plastic, can be coated with particular materials. The cold gas spraying method (also known as kinetic coating, cold spray, kinetic metallisation or kinetic fusion) is a method of this kind. In cold gas spraying, the coating material is in powder form, and is applied on the substrate at very high speed, in particular supersonic speed. For this purpose, a processing gas is used, which is input into an airbrush at high pressure and heated up to temperatures that amount to approximately 1200° C. maximum. As a consequence of the subsequent expansion of the gas in a convergent-divergent nozzle (Laval nozzle), the processing gas accelerates to supersonic speed, and cools down significantly in the process. Here the spraying powder injected into the nozzle is likewise accelerated to supersonic speed and fixedly connects to the substrate due to the high kinetic energy. In comparison with other methods, the spraying material is neither partially melted nor melted in the process.

The technology herein therefore, in example embodiments, creates a method for producing a brake disc, by means of which a brake disc can be produced in a cost-efficient and reliable manner, said brake disc having particularly good wear resistance and temperature and corrosion resistance features. A brake disc having properties of this kind should further be produced.

In the method according to example embodiments of the invention, the friction surface layer is sprayed onto the base body or onto an intermediate layer applied on the base body via cold gas spraying of a particle mixture, wherein the particle mixture consists 25 to 75% by weight of a metal matrix material and 75 to 25% by weight of a carbide material. The metal matrix material consists of one of the following materials:
iron-based alloy
nickel-based alloy
titanium
titanium alloy.

The carbide material consists of one of the following materials:
tungsten carbide,
titanium carbide,
iron carbide,
silicon carbide,
chromium carbide,
niobium carbide.

A friction surface layer that has an extremely high wear resistance is produced on the base body or on an intermediate layer applied on the base body by means of the method according to example embodiments of the invention. The combination of cold spraying methods and sprayed on composite material yields a wear reduction of up to 99% in relation to known brake discs.

The risk of the friction surface layer being delaminated is strongly reduced as a result of the high adhesive strength of the friction surface layer on the base body or on the intermediate layer. The friction surface layer has a very high corrosion resistance. The heat transfer into the base body via the cold gas spraying process is very low, such that a warpage of the base body is minimised or excluded. If an iron-based alloy, titanium or a titanium alloy is used as a metal matrix material, materials which endanger the environment, e.g., nickel or copper, are avoided. Due to the improved properties of the friction surface layer, it is even possible to produce the base body for very high-performance disc brakes from a light material, for example from light metal, whereby the weight of the brake disc can be significantly reduced. Furthermore, brake discs can be produced in a very cost-effective manner by means of the method according to example embodiments of the invention due to the highly efficient cold gas spraying process in combination with the particle mixture according to example embodiments of the invention.

The friction surface layer according to example embodiments of the invention can be sprayed directly onto the base body of the brake disc or onto an intermediate layer previously applied on the base body. According to an advantageous embodiment, the intermediate layer is likewise sprayed onto the base body via cold gas spraying of a particulate metal matrix material, wherein the particulate metal matrix material consists of the following materials:
iron-based alloy,
nickel-based alloy,
titanium,
titanium alloy.

The intermediate layer can consist of the same metal matrix material or a different metal matrix material than the metal matrix material of the friction surface layer. For example, it is possible that the metal matrix material of the intermediate layer consists of an iron-based alloy, while the metal matrix material of the friction surface layer, i.e., of the composite material, consists of a nickel-based alloy, titanium or titanium-alloy. The material of the intermediate layer is suitably chosen, depending on the material of the base body on the one hand and of the friction surface layer on the other, in such a way that it generates a particularly good adherence of the layers to each other and on the base body.

According to an advantageous embodiment, the iron-based alloy that is used for the metal matrix material of the friction surface layer and/or intermediate layer contains 5 to 40% by weight chromium. Particularly cost-effective corrosion properties can thus be generated.

According to an advantageous embodiment, the titanium alloy that is used for the metal matrix material of the friction surface layer and/or intermediate layer contains 5.5 to 6.75% by weight aluminium and 3.5 to 4.5% by weight vanadium. Friction surface layers and intermediate layers can thus be produced that are particularly stable and heat-resistant.

According to an advantageous embodiment, the base body is brushed by means of blasting processes, mechanically, chemically or by means of a laser, before being sprayed in a region onto which the particle mixture forming the friction surface layer or the particulate metal matrix material forming the intermediate layer is sprayed. A particularly good adherence of the friction surface layer or intermediate layer on the base body is thus generated.

Example embodiments further provide a brake disc for a disc brake, wherein the brake disc has a base body and, on at least one side of the base body, a friction surface layer having a friction surface. The friction surface layer of the brake disc consists of a composite material, which is produced by cold gas spraying a particle mixture onto the base body or onto an intermediate layer applied on the base body, wherein the particle mixture consists 25 to 75% by weight of a metal matrix material and 75 to 25% by weight of a carbide material. The metal matrix material consists of one of the following materials:
iron-based alloy
nickel-based alloy
titanium
titanium alloy.

The carbide material consists of one of the following materials:
tungsten carbide
titanium carbide
iron carbide
silicon carbide
chromium carbide
niobium carbide.

The same technical effects and advantages are generated by means of the brake disc as described above in connection with the method for producing the brake disc.

The base body preferably consists entirely or partially of cast steel, grey cast iron, cast aluminium, polymer or composite materials.

### BRIEF DESCRIPTION OF THE DRAWINGS

Example embodiments of the invention are illustrated in more detail in the following by means of the drawings. In the drawings:

FIG. 1: shows a cross-sectional view through a brake disc according to a first exemplary embodiment of the invention;

FIG. 2: shows the detail II of FIG. 1 in an enlarged depiction; and

FIG. 3: shows a cross-sectional view of a second exemplary embodiment of the invention corresponding to FIG. 2.

### DETAILED DESCRIPTION OF EXAMPLE EMBODIMENTS

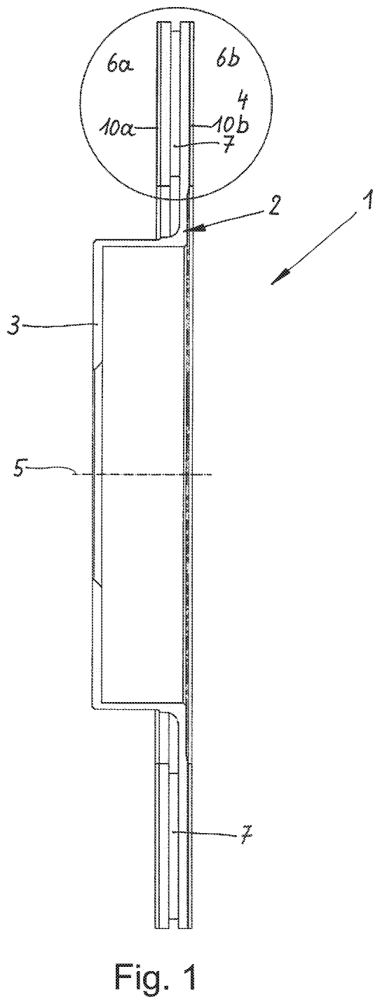

FIG. 1 shows a brake disc 1 for a disc brake of vehicles, for example cars, trucks, motorbikes, bicycles or rail vehicles.

The brake disc 1 comprises a base body 2 having a central part 3 which is cup-shaped in the depicted exemplary embodiment, and a ring-shaped disc body 4 protruding radially outward from the central part 3.

The base body 2 is formed as one part in the depicted exemplary embodiment 1, but can also be formed in multiple parts. The base body preferably consists of cast steel, grey cast iron, cast aluminium, a polymer or composite material.

The central part 3 serves to fix the brake disc 1 on a rotating part in a known way, for example on a hub of the vehicle.

The ring-shaped disc body 4 that protrudes radially outwards over the central part 3 is arranged in a main plane which runs perpendicularly to a central axis 5 of the brake disc 1. In the depicted exemplary embodiment, the disc body 4 further consists in a known way of two parallel ring disc elements 6a, 6b, which are connected to each other by means of several lamellar-shaped connecting bars 7 which are preferably regularly distributed over the circumference of the brake disc 1, and held at a distance from each other, such that a clearance is created between the ring disc elements 6a, 6b. In this way, cooling air can pass between the ring disc elements 6a, 6b, whereby the cooling of the brake disc 1 is improved.

It is also easily possible to coat full discs by means of the method according to example embodiments of the invention.

A friction surface layer 10a, 10b is applied on each of the two sides of the disc body 4, i.e., on the outer lateral surfaces 9a, 9b, by means of a cold gas spraying method. The two friction surface layers 10a, 10b are preferably formed in the same way, and can in particular consist of the same material and have the same thickness. The surfaces of the friction surface layers 10a, 10b facing laterally outward form friction surfaces 11a, 11b. The friction surface layers 10a, 10b in the depicted exemplary embodiment are formed in such a way that brake pads (not shown), which can be moved towards and away from each other on a caliper that is stationary relative to the vehicle, and which have suitable brake linings, can be pressed against the friction surfaces 11a, 11b of the friction surface layers 10a, 10b from opposite sides, wherein the frictional forces required by the brake are generated between the brake pads and the disc body 4.

The friction surface layers 10a, 10b consist of a composite material that consists of a metal matrix material and a carbide material. According to example embodiments of the invention, the metal matrix material consists of an iron-based alloy, preferably having 5 to 40% by weight chromium (with or without additional alloy components), nickel-based alloy, titanium or a titanium alloy, for example Ti6Al4V, having 5.5 to 6.75% aluminium and 3.5% vanadium.

The carbide material consists of tungsten carbide, titanium carbide, iron carbide, silicon carbide, chromium carbide or niobium carbide.

The composite material of the friction surface layers 10a, 10b is generated by spraying on a powder or particle mixture, which consists 25 to 75% by weight of metal matrix material and 75 to 25% by weight of carbide material.

A particularly good adhesion of the friction surface layers 10a, 10b on the disc body 4 can be generated when the lateral surfaces 9a, 9b of the disc body 4 are prepared in a suitable way before coating. In particular, methods can be used by which the lateral surfaces 9a, 9b are brushed. This can occur via blasting processes, mechanical brushing, chemical preparation, laser structuring etc.

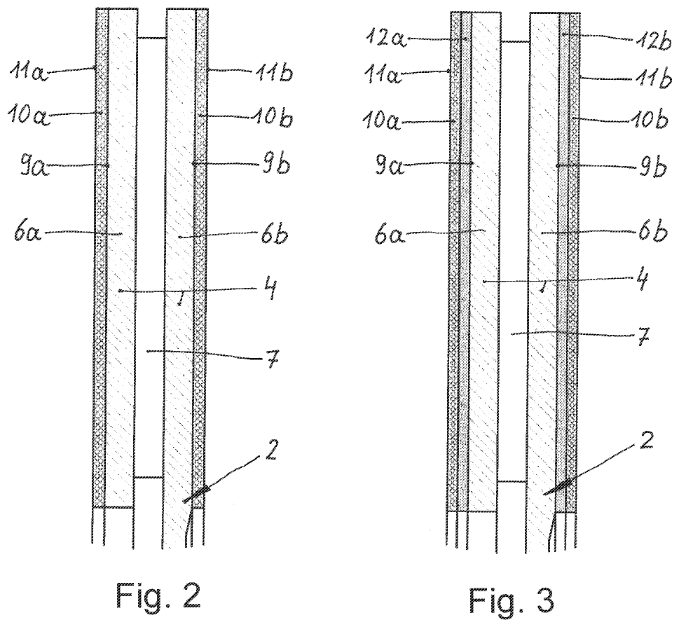

FIG. 3 shows a second exemplary embodiment according to example embodiments of the invention, wherein only that portion of a brake disc is shown which is shown in connection with the first exemplary embodiment in FIG. 2. In the second exemplary embodiment, the base body 2 is identical to the base body 2 of the first exemplary embodiment, such that reference is made to the first exemplary embodiment regarding said base body.

Unlike in the first exemplary embodiment, the friction surface layers 10a, 10b are not directly sprayed onto the disc body 4 of the base body 2 in the second exemplary embodiment, but onto intermediate layers 12a, 12b, which are also sprayed onto the lateral surfaces 9a, 9b of the disc body 4 by means of the cold gas spraying method before the friction surface layers 10a, 10b are sprayed on.

The two intermediate layers 12a, 12b can be formed in the same way. Furthermore, the intermediate layers 12a, 12b consist of a metal matrix material, which can consist of an iron-based alloy (preferably having 5 to 40% chromium), nickel-based alloy, titanium or titanium alloy (e.g., Ti6Al4V, having 5.5 to 6.76% aluminium and 3.5 to 5.5% vanadium).

The metal matrix material of the intermediate layers 12a, 12b can consist of the same or of a different metal matrix material than that of the friction surface layers 10a, 10b.

In the second exemplary embodiment, it can be suitable for the lateral surfaces 9a, 9b of the disc body 4 to be pre-treated, in particular brushed, in a suitable way before the intermediate layers 12a, 12b are sprayed on. This can occur by means of the same method as described in connection with the first exemplary embodiment.

1. Method for producing a brake disc which has a base body and, on at least one side of the base body, a friction surface layer having a friction surface, wherein the friction surface layer is sprayed onto the base body or onto an intermediate layer applied on the base body via cold gas spraying of a particle mixture, wherein the particle mixture consists 25 to 75% by weight of a metal matrix material and 75 to 25% by weight of a carbide material, wherein the metal matrix material consists of one of the following materials:
iron-based alloy
nickel-based alloy
titanium
titanium alloy,
and wherein the carbide material consists of one of the following materials:
tungsten carbide
titanium carbide
iron carbide
silicon carbide
chromium carbide
niobium carbide.

2. Method according to claim 1, wherein the intermediate layer is sprayed onto the base body via cold gas spraying of a particulate metal matrix material, wherein the particulate metal matrix material consists of one of the following materials:
iron-based alloy
nickel-based alloy
titanium
titanium alloy.

3. Method according to claim 1, wherein the iron-based alloy contains 5 to 40% by weight chromium.

4. Method according to claim 1, wherein the titanium alloy contains 5.5 to 6.75% by weight aluminium and 3.5 to 4.5% by weight vanadium.

5. Method according to claim 1, wherein the base body is brushed mechanically, chemically or by means of a laser, before being sprayed in a region onto which the particle mixture forming the friction surface layer or the particulate metal matrix material forming the intermediate layer is sprayed.

6. Brake disc for a disc brake, wherein the brake disc has a base body and, on at least one side of the base body, a friction surface layer having a friction surface, wherein the friction surface layer consists of a composite material, which is produced by cold gas spraying a particle mixture onto the base body or onto an intermediate layer applied on the base body, wherein the particle mixture consists 25 to 75% by weight of a metal matrix material and 75 to 25% by weight of a carbide material, wherein the metal matrix material consists of one of the following materials:
iron-based alloy
nickel-based alloy
titanium
titanium alloy,
and wherein the carbide material consists of one of the following materials:
tungsten carbide,
titanium carbide,
iron carbide,
silicon carbide,
chromium carbide,
niobium carbide.

7. Brake disc according to claim 6, wherein the intermediate layer consists at least predominantly of a particulate metal matrix material sprayed onto the base body via cold gas spraying, which consists of one of the following materials:
iron-based alloy
nickel-based alloy
titanium
titanium alloy.

8. Brake disc according to claim 6, wherein the iron-based alloy contains 5 to 40% by weight chromium.

9. Brake disc according to claim 6, wherein the titanium alloy contains 5.5 to 6.75% by weight aluminium and 3.5 to 4.5% by weight vanadium.

10. Brake disc according to claim 6, wherein the base body is brushed mechanically, chemically or by means of a laser, in a region onto which the particle mixture forming the friction surface layer or the particulate metal matrix material forming the intermediate layer is sprayed.

11. Brake disc according to claim 6, wherein the base body consists partially or entirely of cast steel, grey cast iron, cast aluminium, polymer or composite materials.

12. Brake disc for a disc brake, wherein the brake disc has a base body and, on at least one side of the base body, a friction surface layer having a friction surface, wherein the friction surface layer consists of a composite material, which is produced by cold gas spraying a particle mixture onto the base body or onto an intermediate layer applied on the base body, wherein the particle mixture consists 25 to 75% by weight of a metal matrix material and 75 to 25% by weight of a carbide material, wherein the metal matrix material comprises one of the following materials:
iron-based alloy
nickel-based alloy
titanium
titanium alloy,
and wherein the carbide material consists of one of the following materials:
tungsten carbide,
titanium carbide,
iron carbide,
silicon carbide,
chromium carbide,
niobium carbide.
